(19) United States
(12) Patent Application Publication
(10) Pub. No.: US 2011/0204290 A1
(43) Pub. Date: Aug. 25, 2011

(54) SILICON-BASED BLUE-GREEN PHOSPHORESCENT MATERIAL OF WHICH LUMINESCENCE PEAK CAN BE CONTROLLED BY EXCITATION WAVELENGTH AND PROCESS FOR PRODUCING SILICON-BASED BLUE-GREEN PHOSPHORESCENT MATERIAL

(75) Inventors: Nobuyoshi Koshida, Tokyo (JP); Bernard Gelloz, Tokyo (JP)

(73) Assignee: National University Corporation Tokyo University of Agriculture and Technology

(21) Appl. No.: 13/061,592

(22) PCT Filed: Aug. 26, 2009
(86) PCT No.: PCT/JP2009/064890

§ 371 Date: May 12, 2011

(30) Foreign Application Priority Data
Sep. 1, 2008 (JP) 2008-223583

(51) Int. Cl. C09K 11/59; B82Y 30/00; B82Y 40/00

(52) U.S. Cl. 252/301.4 R; 977/773; 977/900

(57) ABSTRACT

Provided is a silicon-based blue phosphorescent material having a longer luminescence lifetime, a high luminescence intensity, and excellent long-term stability and reproducibility. A method for producing a silicon-based blue-green phosphorescent material controllable by an excitation wavelength, which comprises a first step of anodizing the surface of silicon to prepare a nanocrystal silicon or a nanostructure silicon, a second step of processing the nanocrystal silicon or the nanostructure silicon prepared in the first step for rapid thermal oxidation, and a third step of processing the nanocrystal silicon or nanostructure silicon having been processed for rapid thermal oxidation in the second step, for high-pressure water vapor annealing. Further, a silicon-based blue-green phosphorescent material controllable by an excitation wavelength, which comprises a silicon oxide film in which numerous nanoscale crystal silicon or nanostructure silicon embedded therein, and which has a transition property between molecular energy levels through triplet excitons having a relaxation time of not shorter than 1 ms, or luminescence transition through quasi-stable excitation or trap having a relaxation time of not shorter than 1 ms.

### TECHNICAL FIELD

The present invention relates to a silicon-based blue-green phosphorescent material of which the luminescence peak can be controlled by an excitation wavelength, and to a method for producing the same.

### BACKGROUND ART

A silicon-based light-emitting material for blue emission is described in many publications such as typically Patent Document 1. The silicon-based blue-emitting material described in Patent Document 1 is obtained by contacting a silicon crystal substantially composed of silicon atoms alone with oxygen, and emits blue light (photoluminescence (PL) light having a wavelength of at most 450 nm). It is reported that the luminescence lifetime of the silicon-based blue-emitting material is a few nanoseconds.

As in Patent Document 1, the luminescence lifetime of the conventional silicon-based blue-emitting material heretofore proposed in the art is on an order of from nanoseconds to microseconds, and phosphorescence having a long decay time could not be obtained. For efficiency increase and function enhancement of light emission-related or light acceptance-related optical devices, desired is realization of a blue-emitting material having a further longer luminescence lifetime, a higher luminescence intensity, and more excellent long-term stability and reproducibility.

[Patent Document 1] JP-A 2007-284565

### SUMMARY OF THE INVENTION

### Problems that the Invention is to Solve

The present invention has been made in consideration of the above-mentioned situation, and its object is to provide a silicon-based blue phosphorescent material having a longer luminescence lifetime, a higher luminescence intensity, and more excellent long-term stability and reproducibility.

### MEANS FOR SOLVING THE PROBLEMS

For solving the above problems, the present invention provides a method for producing a silicon-based blue-green phosphorescent material controllable by an excitation wavelength, which comprises a first step of anodizing the surface of silicon to prepare a nanocrystal silicon or a nanostructure silicon, a second step of processing the nanocrystal silicon or the nanostructure silicon prepared in the first step for rapid thermal oxidation, and a third step of processing the nanocrystal silicon or the nanostructure silicon having been processed for rapid thermal oxidation in the second step, for high-pressure water vapor annealing.

The invention also provides a silicon-based blue-green phosphorescent material controllable by an excitation wavelength, which comprises a silicon oxide film in which numerous nanoscale crystal silicon or nanostructure silicon embedded in the silicon oxide film, and which has a transition property between molecular energy levels through triplet excitons having a relaxation time of not shorter than 1 ms, or luminescence transition through quasi-stable excitation or trap having a relaxation time of not shorter than 1 ms.

The invention also provides the silicon-based blue-green phosphorescent material of the above, wherein the excitation process of phosphorescence is derived from the energy level intrinsic to an hyperfine silicon having a size of at most 1.5 nm or silicon oxide covering the hyperfine silicon, and the recombination relaxation process is derived from the energy level intrinsic to the hyperfine silicon or silicon oxide covering the hyperfine silicon, or wherein the activation energy in thermal deactivation of the phosphorescence intensity is at least 0.2 eV, or wherein the phosphorescence emission spectrum comprises multiple fine phosphorescent ingredients as reflecting the formation of molecular discrete energy levels, or wherein a rare earth element or a fluorescent dye molecule is introduced and the light emission from the rare earth element or the fluorescent dye molecule is enhanced through the energy transfer effect.

### EFFECT OF THE INVENTION

The invention has made it possible to provide a silicon-based blue-green phosphorescent material capable of being controlled by an excitation wavelength, which has an extremely long luminescence lifetime, a high luminescence intensity, and excellent long-term stability and reproducibility. The invention is the first that has confirmed the expression of a large phosphorescent effect in a silicon-based light-emitting material.

### BRIEF DESCRIPTION OF THE DRAWINGS

FIG. 1 is a view showing the flowchart of the steps of the production method for a phosphorescent material of the invention.

FIG. 2 is a view showing the relationship between the wavelength and the photoluminescence intensity of the sample of Example 1 at a temperature of 300K, as compared with the data of a sample processed for rapid thermal oxidation treatment (RTO) alone.

FIG. 3 is a view showing the emission spectrum (at a measurement temperature of 4K) of the sample of Example 1 as measured with excitation light energy on different levels.

FIG. 4 is a view showing the result of measurement of the sample of Example 1 at a temperature of 4K using, as the excitation light, the light emitted by a YAG laser at a wavelength of 266 nm.

FIG. 5 is a view showing the relationship between the wavelength and the phosphorescence intensity of the sample of Example 1, comparatively for the elapsed time after laser irradiation.

FIG. 6 is a view showing the time-dependent change of the luminescence peak intensity of the sample of Example 1.

FIG. 7 is a view showing the relationship between the wavelength and the phosphorescence intensity of the sample of Example 1, comparatively for the elapsed time after laser irradiation.

FIG. 8 is a view showing the time-dependent change of the luminescence peak intensity of the sample of Example 1.

FIG. 9 is a view showing the time-dependent change of the luminescence peak intensity of the sample of Example 1, comparatively for the ambient temperature.

FIG. 10 is a view showing the temperature dependence of the phosphorescence intensity at a wavelength of 514 nm of the sample of Example 1, in the elapsed time of 50 ms after laser irradiation.

FIG. 11 is a view showing the emission spectrum at a measurement temperature of 4K of the sample of Example 1 using, as the excitation light, the light emitted by a YAG laser at a wavelength of 266 nm (the spectrum in the elapsed time of 140 ms after pulse excitation). The black dotted lines are measured curves; and the red full line is the fitting curve of the sum of the six phosphorescent ingredients shown in the drawing.

FIG. 12 is a view showing the emission spectrum of the sample of Example 2, as measured with the excitation light at a wavelength of 325 nm from a UV laser at room temperature.

### MODE FOR CARRYING OUT THE INVENTION

The invention is characterized by the above, and its embodiments will be described hereinunder.

The silicon-based light-emitting material of the invention is a silicon-based blue-green phosphorescent material controllable by an excitation wavelength, which is significantly characterized in that it comprises a silicon oxide film in which numerous nanoscale crystal silicon or nanostructure silicon embedded therein, and has a transition property between molecular energy levels through triplet excitons having a relaxation time of not shorter than 1 ms, or luminescence transition through quasi-stable excitation or trap having a relaxation time of not shorter than 1 ms. In Examples given hereinunder, the light-emitting ingredient a decay time of 50 ms as a guide was measured and evaluated as the phosphorescence property.

Structurally, the bond unstable in the long run such as the dangling bond and Si—H, as well as the Si—OH bond or the like is removed, and the material forms a high-quality silicon oxide:silicon film with nanoscale crystal silicon or nanostructure silicon embedded therein. The mechanical stress is relaxed, and the non-emitting recombination defect in the interface between the nanocrystal silicon and the silicon oxide film is reduced. As a result, the material expresses silicon-based blue-green phosphorescence controllable by an excitation wavelength. The peak wavelength of the phosphorescence shifts toward the short wavelength side with the increase in the excitation energy. Specifically, the invention enables phosphorescence for which the excitation process is derived from the energy level intrinsic to a hyperfine silicon having a size of at most 1.5 nm or to silicon oxide covering the hyperfine silicon, and the recombination relaxation process is derived from the energy level intrinsic to the hyperfine silicon or to silicon oxide covering the hyperfine silicon.

The phosphorescence duration time depends on temperature, and tends to be constant at a low temperature but to be shortened at around room temperature owing to thermal deactivation. The degree of phosphorescence decay depends on the activation energy for thermal deactivation. The material of the invention may keep a long phosphorescence time even at room temperature, and the activation energy for thermal activation is at least 0.2 eV.

The emission spectrum comprises multiple fine phosphorescent ingredients as reflecting the formation of molecular discrete energy levels.

Introducing a rare earth element or a fluorescent dye molecule into the phosphorescent material of the invention makes it possible to enhance the light emission from the rare earth element or the fluorescent dye molecule through the energy transfer effect. In this case, the rare earth element to be introduced includes all of Tb, Er, Y, Eu, Tm, Nd, Sm, Dy, Ho, Yb and Nd. The amount to be introduced may be from 10⁻⁴ to 10⁻¹ mol/cm³ or so. The fluorescent dye molecule to be introduced includes, for example, rhodamine and its derivatives, rhodamine B, rhodamine 6G, rhodamine 110, etc. The amount to be introduced may be from 10⁻⁵ to 10⁻² mol/cm³ or so.

The phosphorescent material having the above characteristics can be produced according to the following method.

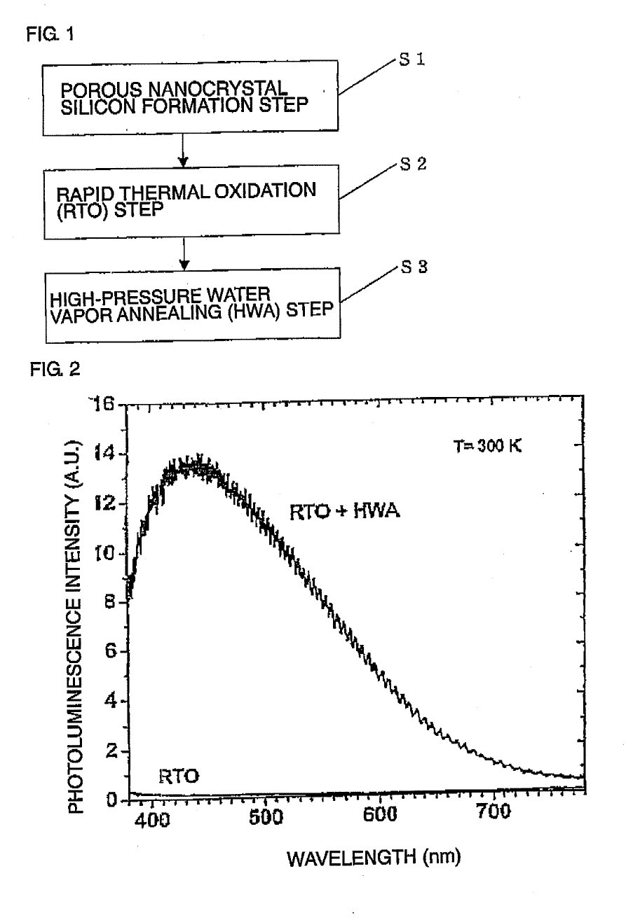

One example of the production method for the silicon-based blue-green phosphorescent material capable of being controlled by an excitation wavelength of the invention (hereinafter this may be referred to as the present phosphorescent material) comprises, as shown in FIG. 1, mainly a porous nanocrystal silicon formation step (S1), a rapid thermal oxidation (RTQ) step (S2) and a high-pressure water-vapor annealing (HWA) step (S3).

First described is the porous nanocrystal silicon formation step (S1). In this step, the surface of a silicon substrate is anodized to form a nanocrystal silicon. The anodization is, for example, as follows: An anode of a silicon substrate and a cathode of a counter electrode of platinum or the like are set in an electrolyzer with an electrolytic solution kept therein, and current is applied between the two electrodes to cause anodization. Through the anodization, a black to brown porous films referred to as a porous silicon is formed on the surface of the silicon substrate. As the electrolytic solution, used is hydrofluoric acid, hydrofluoric acid-ethanol, or the like. The anodization may be attained in a dark place, or may be attained with irradiation with light. The thickness of the porous silicon film may be generally from 0.1 to 500 μm or so. In the porous silicon, there are formed numerous quantum-size silicon nanodots having a diameter of at most 4 nm. In the manner as above, a porous nanocrystal silicon is formed.

Next, in the rapid thermal oxidation (RTO) step (S2), the porous nanocrystal silicon formed in the above is processed for rapid thermal oxidation (RTO). The rapid thermal oxidation (RTO) may be attained, for example, in a dry or wet oxygen gas atmosphere and under the condition at a temperature of from 500 to 1100° C. for a processing time of from 1 minute to 10 hours. Through the rapid thermal oxidation (RTO), an oxide film is formed on the surface of the porous nanocrystal However, in the porous nanocrystal silicon merely processed for rapid thermal oxidation (RTO) alone, there may remain surface defects and mechanical stress therein, and therefore, the blue emission photoluminescence (PL) intensity from the silicon is weak.

Next, in the high-pressure water-vapor annealing (HWA) step (S3) in the invention, the porous nanocrystal silicon processed for rapid thermal oxidation (RTO) as above is processed for high-pressure water vapor annealing (HWA). The high- pressure water vapor annealing (HWA) is as follows: First, deionized water and the porous nanocrystal silicon processed in the above are put in a chamber at room temperature, and sealed up. Subsequently, this is heated up to a temperature of from 100 to 500° C. so as to have a water vapor pressure of from 1 to 5 MPa (10 atmospheres to 50 atmospheres), and annealed for 30 minutes to 10 hours under the condition. The chamber may be, for example, a flange-sealable chamber formed of stainless steel or the like. The present phosphorescent material obtained through this treatment expresses silicon-based blue-green phosphorescence controllable by an excitation wavelength.

The present phosphorescent material produced according to the above-mentioned process has a second-order phosphorescence lifetime, as shown in the following Examples; and as compared with conventional light-emitting materials, the material has an extremely long decay time. This may be considered because the surface of the porous nanocrystal silicon is suitably processed by a combination of rapid thermal oxidation (RTO) and high-pressure water vapor annealing (HWA).

The base material silicon to be anodized may be any of not only a monocrystalline silicon wafer, but also a polycrystalline silicon layer or an amorphous silicon layer deposited on a monocrystalline silicon substrate or a conductive film- coated glass or a flexible film substrate, as well as a monocrystalline silicon layer epitaxially grown on an insulator substrate (silicon on insulator: SOI).

So far as the phosphorescent material satisfies both two of the structural requirement that the material comprises a silicon oxide film in which numerous nanoscale crystal silicon or nanostructure silicon embedded in the silicon oxide film, and the physical requirement that the material has a transition property between molecular energy levels through triplet excitons having a relaxation time of not shorter than 1 ms, or luminescence transition through quasi-stable excitation or trap having a relaxation time of not shorter than 1 ms, its production method is not limited to anodization alone, but may include any other wet process or dry process.

The invention will be described in more detail with reference to the following Examples.

### Example 1

A p-type silicon substrate having a dimension of 1.2 cm×1.2 cm×500 μm (4 Ω·cm) was prepared as an anode, and platinum was prepared as a cathode. In an electrolytic solution of 55% hydrofluoric acid/ethanol (1/1), the silicon substrate was anodized in a constant current mode at a current (current density) of 50 mA/cm² for 15 minutes to form a porous nanocrystal silicon. In this stage, the thickness of the porous silicon layer was 35 μm.

Next, the thus-anodized porous nanocrystal silicon was processed for rapid thermal oxidation (RTO) in a dry oxygen gas atmosphere at 900° C. for 30 minutes.

Next, the porous nanocrystal silicon thus processed for rapid thermal oxidation (RTO) and deionized water were put in a stainless steel-made flange-sealable chamber at room temperature, and sealed up. This was processed for high-pressure water vapor annealing (HWA) under a water vapor pressure of 3.9 MPa and at a temperature of 260° C. for 3 hours.

For confirming the level of the luminescence intensity, the photoluminescence (PL) intensity at 300K of the sample obtained in Example is shown in FIG. 2. The horizontal axis indicates a wavelength. For the measurement, the light at a wavelength of 325 nm emitted by a He—Cd laser was used as the excitation light. In FIG. 2, additionally shown are the data of the sample merely processed for rapid thermal oxidation (RTO) alone as Comparative Example. The photoluminescence intensity of the sample of Comparative Example is extremely weak as compared with the sample of Example, from which a significant difference between the two is known in the luminescence intensity.

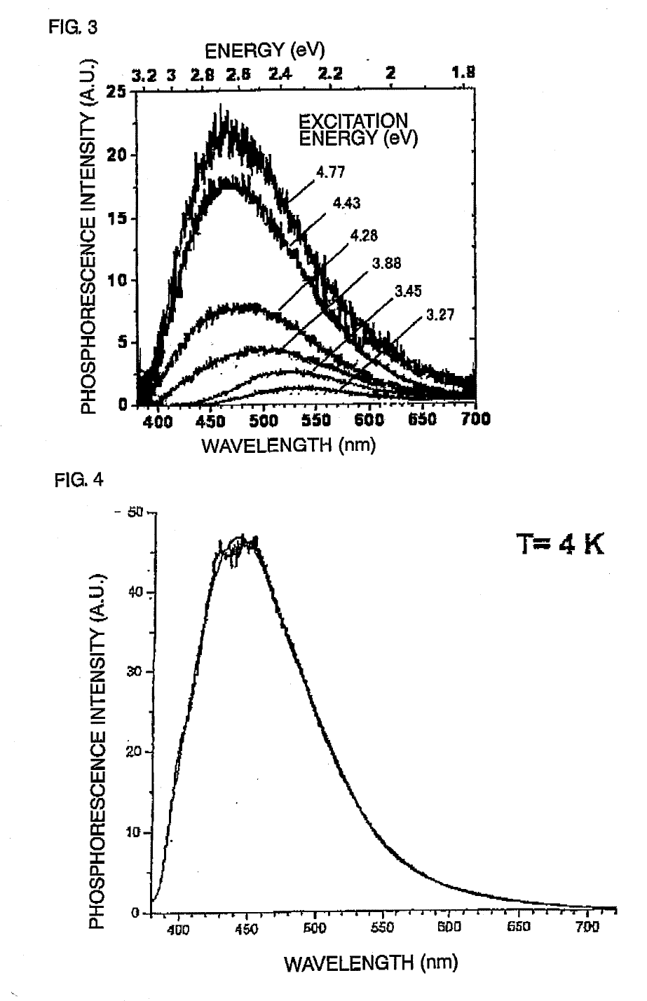

Next, the sample prepared in the above was analyzed for the emission spectrum in the elapsed time of 50 ms after the end of the excitation, for which the excitation light energy was varied (measurement temperature was 4K). The results are shown in Fig, 3. Photoluminescence itself decays fast, and the luminescence lifetime is merely from microsecond to nanosecond though depending on the wavelength; and the results in FIG. 3 indicate the appearance of phosphorescence different from photoluminescence. It is also known that with the increase in the excitation energy, the peak wavelength of the phosphorescence can be controlled in a range of from green to blue.

Using the light from a YAG laser at a wavelength of 266 nm (energy: 4.66 eV) as the excitation light, the sample was analyzed for the emission spectrum at 4K in the elapsed time of 50 ms after the end of the excitation. The results are shown in FIG. 4. As expected from the results in FIG. 3, the sample gave blue-zone phosphorescence corresponding to the excitation energy.

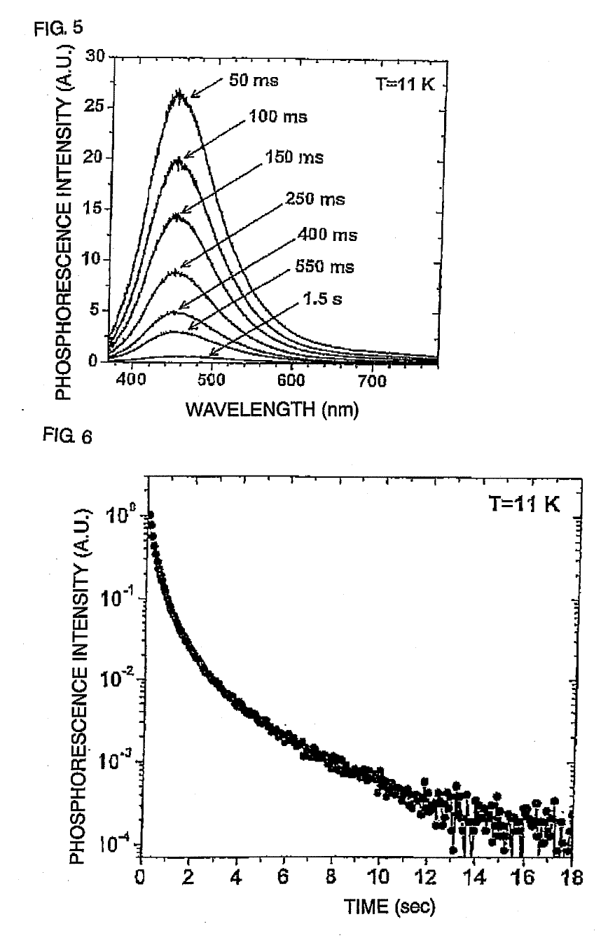

Using the light from a YAG laser at a wavelength of 266 nm as the excitation light, the sample prepared in the above was analyzed at 11K. FIG. 5 shows the relationship between the wavelength and the phosphorescence intensity of the sample, comparatively for the elapsed time after laser irradiation, FIG. 6 shows the time-dependent change of the luminescence peak intensity of the sample. These drawings confirm that the sample of this Example has a second-order lifetime and expressed a phosphorescent effect. As known from FIG. 5, the blue phosphorescence peak wavelength does not change depending on the time, but only the peak intensity decreases.

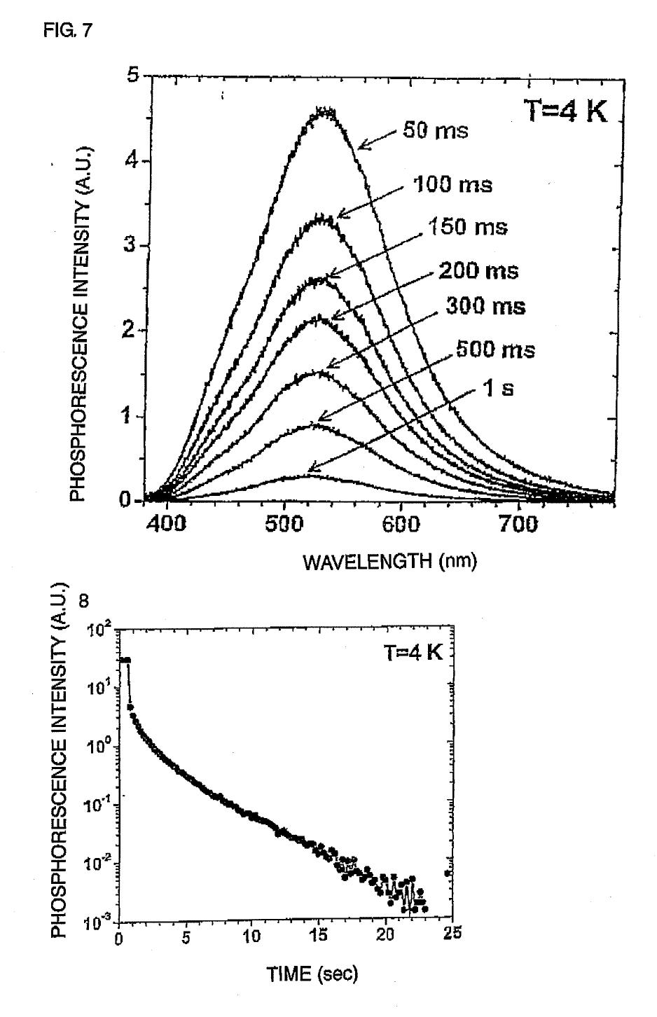

Using the light from a nitrogen laser at a wavelength of 337 nm (energy; 3.68 eV) as the excitation light, the sample prepared in the above was analyzed at 4K. FIG. 7 shows the relationship between the wavelength and the phosphorescence intensity of the sample, comparatively for the elapsed time after laser irradiation. FIG. 8 shows the time-dependent change of the luminescence peak intensity of the sample. These drawings confirm that the sample of this Example has a second- order lifetime and expressed a phosphorescent effect. As known from FIG. 7, the phosphorescence is in a green region as anticipated from FIG. 3, and while its peak wavelength is kept constant, only the peak intensity decreases with the lapse of time.

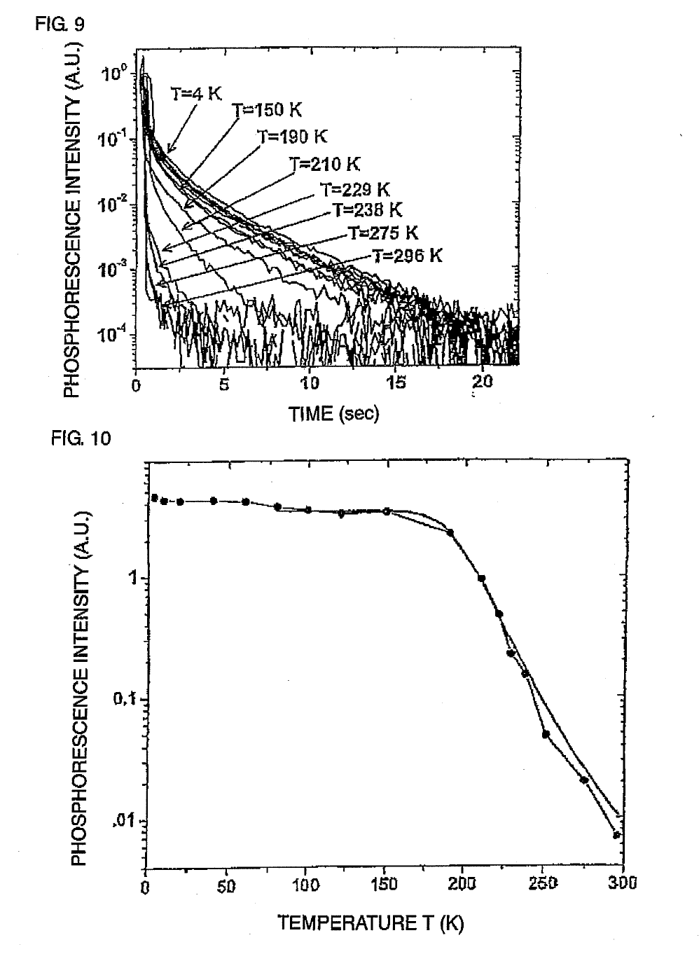

Using the light from a nitrogen laser at a wavelength of 337 nm as the excitation light, the sample prepared in the above was analyzed for the temperature dependence of the phosphorescence intensity thereof. FIG. 9 shows the time- dependent change of the luminescence peak intensity of the sample, comparatively for the ambient temperature. FIG. 10 shows the temperature dependence of the phosphorescence intensity at a wavelength of 514 nm of the sample, in the elapsed time of 50 ms after laser irradiation. From these drawings, it is known that the phosphorescence has temperature dependence, and the influence of temperature thereon becomes significant at 180K or higher. In this Example, the activation energy in thermal deactivation is 0.29 eV.

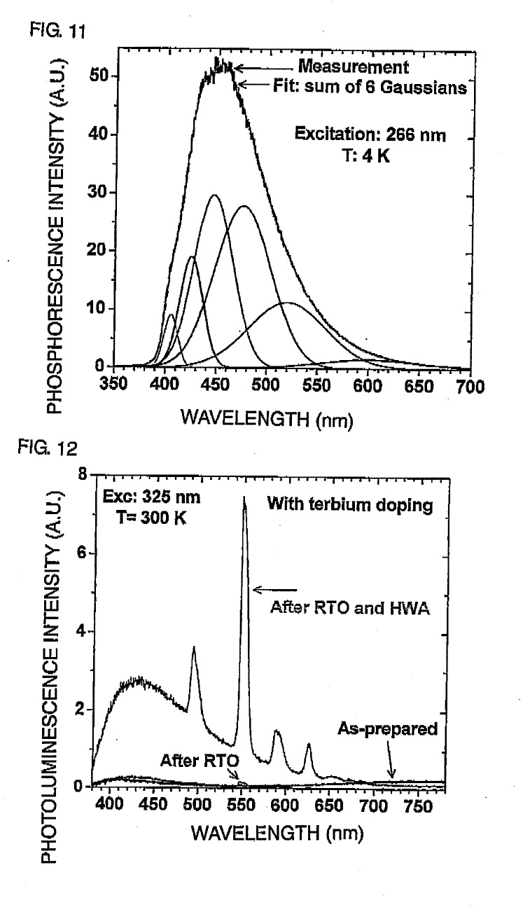

Further, in this sample showing remarkable phosphorescence, it is expected that the emission spectrum would comprise multiple fine phosphorescent ingredients as reflecting the formation of molecular discrete energy levels. The sample prepared under the above-mentioned condition was analyzed for the phosphorescence properties thereof in detail; and as a result, as shown in FIG. 11, it has been verified that the emission spectrum comprises a phosphorus ingredient having multiple peaks (in this Example, having 6 peaks). In this case, the light from a YAG laser at a wavelength of 266 nm is used as the excitation light; and the measurement temperature is 11K. The phosphorescence of each peak wavelength has nearly the same lifetime, and it has been confirmed that each phosphorescence appeared nearly in the same relaxation process.

For porous silicon, the condition of rapid thermal oxidation (RTO) and that of high-pressure water vapor annealing (HWA) in anodization depend on the initial porosity (20 to 80%). The range of the rapid thermal oxidation (RTO) condition (temperature of from 500 to 1100° C., processing time of from 1 minute to 10 hours) and that of the high-pressure water-vapor annealing (HWA) condition (water vapor pressure of from 1 to 5 MPa, temperature of from 100 to 500° C., time of from 30 minutes to 10 hours) mentioned above reflect the porosity; and the phosphorescent effect was confirmed not only in the above Example but also with the samples prepared within the range of the above-mentioned condition and defined in accordance with the porosity in anodization.

### Example 2

A p-type silicon substrate having a dimension of 1.2 cm×1.2 cm×500 μm (4 Ω·cm) was prepared as an anode, and platinum was prepared as a cathode. In an electrolytic solution of 55% hydrofluoric acid/ethanol (1/1), the silicon substrate was anodized in a constant current mode at a current (current density) of 50 mA/cm² for 4 minutes to form a porous nanocrystal silicon. In this stage, the thickness of the porous silicon layer was 10 μm.

Next, the thus-anodized porous nanocrystal silicon layer was electrolyzed in an aqueous 1 M TbCl₃ solution at a constant voltage (at −4V relative to the Ag/AgCl standard electrode) for 15 minutes. The electrochemical deposition introduced the rare earth metal Tb into the porous silicon layer.

The Tb-introduced porous nanocrystal silicon layer was processed for rapid thermal oxidation (RTO) in a dry oxygen gas atmosphere at 900° C. for 30 minutes.

Further, the porous nanocrystal silicon and deionized water were put in a stainless steel-made flange-sealable chamber at room temperature, and sealed up. This was processed for high-pressure water vapor annealing (HWA) under a water vapor pressure of 3.9 MPa and at a temperature of 260° C. for 3 hours.

FIG. 12 shows the emission spectrum of the sample in each step (the excitation light was from a UV laser at a wavelength of 325 nm, and the measurement temperature was room temperature). The emission from the sample before RTO was weak in the entire wavelength range, and the sample gave no emission from Tb. After RIO, the sample gave some but slight emission from Tb. As opposed to these, the sample after HWA treatment clearly increased the blue-zone emission including the phosphorescent ingredient, and at the same time, the emission peak by Tb increased noticeably.

The results indicate that the light energy was transferred to Tb in the process of blue phosphorescence, therefore inducing luminescence excitation.

1-6. (canceled)

7. A method for producing a silicon-based blue-green phosphorescent material controllable by an excitation wavelength, which comprises a first step of anodizing the surface of silicon to prepare a nanocrystal silicon or a nanostructure silicon, a second step of processing the nanocrystal silicon or the nanostructure silicon prepared in the first step for rapid thermal oxidation, and a third step of processing the nanocrystal silicon or the nanostructure silicon having been processed for rapid thermal oxidation in the second step, for high-pressure water vapor annealing under from 1 to 5 MPa.

8. A silicon-based blue-green phosphorescent material controllable by an excitation wavelength, which comprises a silicon oxide film in which numerous nanoscale crystal silicon or nanostructure silicon embedded therein, and which has a transition property between molecular energy levels through triplet excitons having a relaxation time of not shorter than 1 ms, or luminescence transition through quasi-stable excitation or trap having a relaxation time of not shorter than 1 ms.

9. The silicon-based blue-green phosphorescent material as claimed in claim 8, wherein the excitation process of phosphorescence is derived from the energy level intrinsic to an hyperfine silicon having a size of at most 1.5 nm or silicon oxide covering the hyperfine silicon, and the recombination relaxation process is derived from the energy level intrinsic to the hyperfine silicon or to silicon oxide covering the hyperfine silicon.

10. The silicon-based blue-green phosphorescent material as claimed in claim 8, wherein the activation energy in thermal deactivation of the phosphorescence intensity is at least 0.2 eV.

11. The silicon-based blue-green phosphorescent material as claimed in claim 9, wherein the activation energy in thermal deactivation of the phosphorescence intensity is at least 0.2 eV.

12. The silicon-based blue-green phosphorescent material as claimed in claim 8, wherein the emission spectrum comprises multiple fine phosphorescent ingredients as reflecting the formation of molecular discrete energy levels.

13. The silicon-based blue-green phosphorescent material as claimed in claim 9, wherein the emission spectrum comprises multiple fine phosphorescent ingredients as reflecting the formation of molecular discrete energy levels.

14. The silicon-based blue-green phosphorescent material as claimed in claim 10, wherein the emission spectrum comprises multiple fine phosphorescent ingredients as reflecting the formation of molecular discrete energy levels.

15. The silicon-based blue-green phosphorescent material as claimed in claim 11, wherein the emission spectrum comprises multiple fine phosphorescent ingredients as reflecting the formation of molecular discrete energy levels.

16. The silicon-based blue-green phosphorescent material as claimed in claim 8, wherein a rare earth element or a fluorescent dye molecule is introduced and the light emission from the rare earth element or the fluorescent dye molecule is enhanced through the energy transmission effect.

17. The silicon-based blue-green phosphorescent material as claimed in claim 9, wherein a rare earth element or a fluorescent dye molecule is introduced and the light emission from the rare earth element or the fluorescent dye molecule is enhanced through the energy transmission effect.

18. The silicon-based blue-green phosphorescent material as claimed in claim 10, wherein a rare earth element or a fluorescent dye molecule is introduced and the light emission from the rare earth element or the fluorescent dye molecule is enhanced through the energy transmission effect.

19. The silicon-based blue-green phosphorescent material as claimed in claim 11, wherein a rare earth element or a fluorescent dye molecule is introduced and the light emission from the rare earth element or the fluorescent dye molecule is enhanced through the energy transmission effect.

20. The silicon-based blue-green phosphorescent material as claimed in claim 12, wherein a rare earth element or a fluorescent dye molecule is introduced and the light emission from the rare earth element or the fluorescent dye molecule is enhanced through the energy transmission effect.
